(19) United States
(12) Patent Application Publication
(10) Pub. No.: US 2023/0183531 A1
(43) Pub. Date: Jun. 15, 2023

(54) SEAM TAPE AND RELATED METHODS AND PRODUCTS

(71) Applicant: Celgard, LLC, Charlotte, NC (US)

(72) Inventors: Barry J. Summey, Lake Wylie (SC); Insik Jeon, Ithaca, NY (US); Kang Karen Xiao, Mississauga (CA); Eric R. White, Fort Mill, SC (US); Stefan Reinartz, Waxhaw, NC (US)

(21) Appl. No.: 17/920,028

(22) PCT Filed: Apr. 19, 2021
(86) PCT No.: PCT/US2021/027861

§ 371 Date: Oct. 20, 2022

Related U.S. Application Data
(60) Provisional application No. 63/012,287, filed on Apr. 20, 2020.

(51) Int. Cl. C09J 123/14; C09J 7/35; C09J 7/21

(52) U.S. Cl. CPC C09J 123/14; C09J 7/21; C09J 7/35; C09J 2301/304; C09J 2301/312

(57) ABSTRACT

A polyolefin-containing seam tape is described herein. The polyolefin may be at least one of a homopolymer, copolymer, terpolymer, or a polymer blend of polyethylene, polypropylene, or a combination of the two. The seam tape may be used to form a bonded, reinforced, or waterproofed seam. The seam tape may be used in equipment or apparel that may or may not be recyclable.

### CROSS REFERENCE TO RELATED APPLICATIONS

This application is a 371 U.S. Application claiming priority to PCT/US2021/027861, filed Apr. 19, 2021, which claims priority to U.S. Provisional Pat. Application Serial No. 63/012,287, filed Apr. 20, 2020, which is hereby fully incorporated by reference herein.

### FIELD

This application is directed to seam tapes, particularly polypropylene-containing seam tapes. Methods for using the seam tapes and products containing the seam tapes are also disclosed.

### BACKGROUND

Seam tapes may be used for a variety of purposes, including bonding a seam, reinforcing a seam, and waterproofing a seam.

Seam tapes may be used to make athletic clothing, outdoor clothing, etc. With a new push to make these types of clothing recyclable, it is important that the entire piece of clothing be made of the same or be made substantially of the same material. Some athletic clothing and outdoor clothing may be made of two, two-and-one-half, three, or more layers containing polypropylene. The seams of these garments may be bonded, reinforced, or waterproofed using a seam tape. For recyclability, it is desirable that the seam tape also contain polypropylene.

### SUMMARY

In one aspect, a seam tape comprising, consisting of, or consisting essentially of a porous or non-porous film is described herein. The porous or non-porous film may comprise, consist of, or consist essentially of a polypropylene-containing material that has a Vicat softening point of 150° C. or less or between 45° C. and 150° C. In some embodiments, the polypropylene-containing material is a copolymer containing more than 50%, more than 60%, more than 70%, more than 80%, more than 90%, or more than 90% polypropylene. The copolymer may be a block copolymer. In some embodiments, the block copolymer or copolymer is a polypropylene-polyethylene block copolymer or copolymer. In some embodiments, the polypropylene-containing material is a terpolymer containing more than 50%, more than 60%, more than 70%, more than 80%, more than 90%, or more than 90% polypropylene. In some embodiments, the terpolymer is a block terpolymer. In some embodiments, the polypropylene-containing material is a polymer blend containing more than 50%, more than 60%, more than 70%, more than 80%, more than 90%, or more than 90% polypropylene. In some embodiments, the polymer blend is a mixture of polypropylene and another polyolefin, including another type of polypropylene. The porous or non-porous film comprising, consisting of, or consisting essentially of the propylene-containing material itself has a softening point between 45° C. and about 150° C. The porous or non-porous film may be macroporous, microporous, or nanoporous.

In some embodiments, the seam tape may consist of the porous or non-porous film or layer. However, in some embodiments, the seam tape may further comprise, consist of, or consist essentially of at least one selected from the group consisting of a support layer, a release film or layer, and combinations thereof. In some embodiments, the seam tape has a release film or layer on one or both sides of the porous or non-porous film. In some embodiments, the seam tape has a support layer on one side of the porous or non-porous film and a release layer on the other side. The support layer may be made of a fabric, including a jersey, nylon-containing, or spandex-containing fabric.

In some embodiments described herein, the seam tape is a seam reinforcement tape, a seam bonding tape, or a waterproofing seam tape. In some embodiments, a bonding seam tape may have a release film or layer on either side of the porous or non-porous film. In some embodiments, the seam reinforcement tape or seam waterproofing tape may have a support film on one side of the porous or non-porous film and a release film or layer on the other side.

In another aspect, another seam-tape variant is disclosed herein. The seam tape may comprise, consist of, or consist essentially of a polyolefin-containing adhesive. The polyolefin-containing adhesive may be at least one selected from the group of a hot melt adhesive and pressure sensitive adhesive. The seam tape may comprise, consist of or consist essentially of a polyolefin-containing adhesive in the form of a film, layer, or strip, and a surface of the film, layer or strip may optionally formed or treated to improve properties such as the tack of the polyolefin-containing film, layer, or strip. In some embodiments, the polyolefin-containing adhesive may be free-standing or self-supported. In such embodiments, a release liner or film may be formed on one or two sides thereof to, for example, protect the adhesive.

In some embodiments, the polyolefin-containing adhesive may be freestanding or self-supported and in other embodiments, the polyolefin-containing adhesive may be formed on a support or substrate. The support or substrate may be a monolayer support, a bilayer support, or a support having three or more layers. The adhesive may be formed continuously or non-continuously on the substrate and may cover all or less than all of the support or substrate. The support or substrate material is not so limited, but may be at least one selected from a fabric, including a jersey fabric, nylon fabric, a spandex fabric, etc., a polyolefin-containing film, and a polyurethane-containing film. In some embodiments, the support or substrate may be a bilayer substrate comprising two layers of the same or a different material. In some embodiments, the bi-layer substrate or support may include a polyolefin-containing film that may be porous or nonporous and a fabric film or layer. In some embodiments, the fabric film or layer may be formed from polyolefin-containing fibers. In some embodiments, a seam tape comprising a bilayer support may comprise a fabric film or layer, a polyolefin-containing film or layer, and a polyolefin-containing adhesive in that order. The seam tape of claim 65, wherein the polyolefin-containing film is porous or non-porous. A release film or layer may be formed on an exposed surface of the polyolefin-containing adhesive to, for example, protect the adhesive.

In another aspect, another seam tape is disclosed. The seam tape may comprise, consist of, or consist essentially of a bonding layer comprising, consisting of, or consisting essentially of a polyolefin. The bonding layer comprising a polyolefin may be freestanding or self-supporting or may be provided on a support. The bonding layer may be continuously or non-continuously provided on the support. It may cover a whole surface of the support or less than a whole surface of the support. In some embodiments, the bonding may comprise a polyolefin having a softening point from about 70° C. to about 110° C. In some embodiments, the bonding layer may comprise a polyethylene or polypropylene homopolymer, copolymer, terpolymer, or polymer blend comprising polypropylene or polyethylene. In some embodiments, the polyolefin may be a low density or ultra-low density polypropylene or polyethylene homopolymer, copolymer, terpolymer, etc.

The support may be a monolayer support or a bilayer support. The support may have a softening temperature that is at least about 50° C. above that of the bonding layer. This is so that the support does not melt, soften, or deform when the bonding layer is heated. In some embodiments, the support is a bilayer support that comprises a waterproof and/or breathable layer and an exposed layer. Sometimes the seam tape disclosed herein may comprise a bonding layer, a waterproof/breathable layer, and an exposed layer provided in that order.

The waterproof/breathable layer may comprise, consist of, or consist essentially of a polyolefin homopolymer, copolymer, terpolymer or a polymer blend comprising consisting of, or consisting essentially of a polyolefin. In some embodiments, the waterproof/breathable layer comprises, consists of, or consists essentially of a polypropylene or polyethylene homopolymers, copolymers, or terpolymers, or a polymer blend comprising polypropylene or polyethylene. The waterproof/breathable layer may be porous or non-porous. In some embodiments, the waterproof/breathable layer may have a softening temperature that is at least about 50° C. above that of the bonding layer so that, for example, the layer does not melt, deform, or soften when the bonding layer is heated as the seam tape is used for its intended purpose. In some embodiments, the softening temperature may be above 150° C.

The exposed layer may be a textile or fabric. In some embodiments, the exposed layer may be a layer that has good hand. For example, the exposed layer may be a textile or coating that has good hand. In some embodiments, the exposed layer has a softening point that is about 50° C. higher or more than the bonding layer so that the exposed layer does not deform, melt or soften at the same temperature as the bonding layer does. In some embodiments, the exposed layer has a softening temperature that may be above 150° C. In some embodiments, the exposed layer may comprise, consist of, or consist essentially of a polyolefin homopolymer, copolymer, terpolymer or a polyolefin polymer blend. In some embodiments, the it may be a polyethylene or polypropylene homopolymer, copolymer, or terpolymer or a polypropylene or polyethylene polymer blend. The textile or fabric may be a textile of fabric comprising, consisting of, or consisting essentially of polyolefin fibers.

In some embodiments, a seam tape may comprise a bonding layer, a waterproof/breathable layer, and an exposed layer in that order. The may be laminated or coextruded together. In some embodiments, the seam tape may comprise at least two of the bonding layer, the breathable/waterproof layer, and the exposed layer coextruded together. In some embodiments, all of the bonding layer, the breathable/waterproof layer, and the exposed layer coextruded together. In some embodiments, the bonding layer, the breathable/waterproof layer, and the exposed layer coextruded together in that order.

In another aspect, a method for bonding a seam using any seam tape disclosed herein is disclosed. The method may comprise providing a seam tape as disclosed herein and two pieces or sides of material to be bonded together. The method may also comprise bonding the pieces of material together using the seam tape. The pieces of material may be the same type of material or different types of material. Bonding the pieces of material together may comprise, consist of, or consist essentially of placing one side of the seam tape onto a surface of one piece of material, placing a surface of another of the pieces of material on the other side of the seam tape, and applying heat. In some embodiments, placing may involve tacking a side of the seam tape to one or more of the pieces of material. Heat may be applied by at least one selected from the group consisting of a heat press machine, a lamination belt, an iron, and a hot air machine. In some embodiments, the seam formed herein is not a sewn seam. In some embodiments, the seam tape used to form the bonded seam comprises, consists of or consists essentially of the porous or non-porous film and a release layer or film on at least one side of the porous or non-porous film. In some embodiments, the seam tape may comprise, consist of, or consist essentially of an adhesive film or layer or a bonding layer with release films optionally formed on one or more surfaces of the adhesive film or layer or the bonding layer. In some embodiments, the release layer or film may be removed prior to placing the porous or non-porous film on a surface of a piece of material. A bonded seam may also be formed by using a seam tape disclosed herein to bond a bias bound seam.

In another aspect, a method for reinforcing a seam using a seam tape as described herein is disclosed. The method may comprise placing the seam tape over the seam. In some embodiments, the seam may be approximately centered under the seam tape. In some embodiments, the seam being reinforced may be a sewn seam or an ultrasonic line bonded seam. In preferred embodiments, the method for reinforcing a seam further comprises a step of applying heat. Heat may be applied by at least one of the following methods: heat press machine, lamination belt, iron, and hot air machine. In some embodiments, a porous or nonporous film, an adhesive layer, or a bonding layer may be placed over the seam in direct or in indirect contact with the seam.

In another aspect, a method for waterproofing a seam using a seam tape described herein is disclosed. The method may comprise a step of placing the seam tape on the seam. In further embodiments, the method may further comprise applying heat to the seam directly or indirectly. Heat may be applied using at least one selected from the group consisting of: a heat press machine, a lamination belt, an iron, and a hot air machine. In some embodiments, the seam that is undergoing waterproofing is a sewn seam.

In one aspect, a reinforced seam comprising a seam tape as disclosed herein is disclosed. In some embodiments, the materials forming the seam and the seam tape comprise, consist of, or consist essentially of a polypropylene-containing polymer, copolymer, terpolymer, or polymer blend. In some embodiments, the materials and the seam tape consist or consist essentially of a polypropylene-containing polymer, copolymer, terpolymer, or polymer blend. In some embodiments, the materials and the seam tape consist of or consist essentially of a polypropylene-containing copolymer. In some embodiments, the materials and the seam tape consist of or consist essentially of a polypropylene-polyethylene block copolymer wherein the amount of polyethylene is up to 49%, preferably up to 40%, 30%, or 20%, and most preferably up to 10% or 5%.

In one aspect, a bonded seam comprising a seam tape disclosed herein is disclosed. In some embodiments, the materials forming the seam and the seam tape comprise, consist of, or consist essentially of a polypropylene-containing polymer, copolymer, terpolymer, or polymer blend. In some embodiments, the materials and the seam tape consist or consist essentially of a polypropylene-containing polymer, copolymer, terpolymer, or polymer blend. In some embodiments, the materials and the seam tape consist of or consist essentially of a polypropylene-containing copolymer. In some embodiments, the materials and the seam tape consist of or consist essentially of a polypropylene-polyethylene block copolymer wherein the amount of polyethylene is up to 49%, preferably up to 40%, 30%, or 20%, and most preferably up to 10% or 5%.

In one aspect, a waterproof seam comprising a seam tape disclosed herein is disclosed. In some embodiments, the materials forming the seam and the seam tape comprise, consist of, or consist essentially of a polypropylene-containing polymer, copolymer, terpolymer, or polymer blend. In some embodiments, the materials and the seam tape consist or consist essentially of a polypropylene-containing polymer, copolymer, terpolymer, or polymer blend. In some embodiments, the materials and the seam tape consist of or consist essentially of a polypropylene-containing copolymer. In some embodiments, the materials and the seam tape consist of or consist essentially of a polypropylene-polyethylene block copolymer wherein the amount of polyethylene is up to 49%, preferably up to 40%, 30%, or 20%, and most preferably up to 10% or 5%.

In another aspect, a recyclable garment comprising a seam tape disclosed herein is disclosed.

### DESCRIPTION OF DRAWINGS

FIG. 1 is a schematic drawing of a microporous membrane according to some embodiments described herein.

FIG. 2A and FIG. 2B are FESM images of microporous membranes according to some embodiments described herein.

FIG. 3 is a schematic drawing demonstrating the concept of tortuosity.

FIG. 4 is a schematic drawing of some embodiments described herein.

FIG. 5 is a schematic drawing of some embodiments described herein.

FIG. 6 is a schematic drawing of some embodiments described herein.

FIG. 7 is a schematic drawing of some embodiments described herein.

FIG. 8 is a schematic drawing of some embodiments described herein.

FIG. 9 is a schematic drawing of some embodiments described herein.

FIG. 10 is a schematic drawing of some embodiments described herein.

FIG. 11 is a schematic drawing of some embodiments described herein.

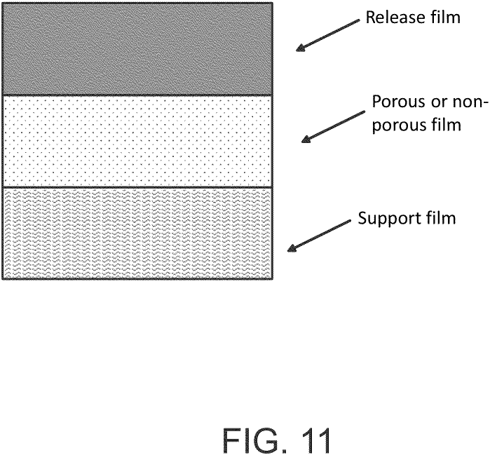

FIG. 12 is a schematic drawing of some embodiments described herein.

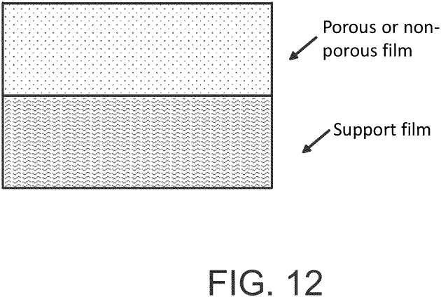

FIG. 13 is a schematic drawing of some embodiments described herein.

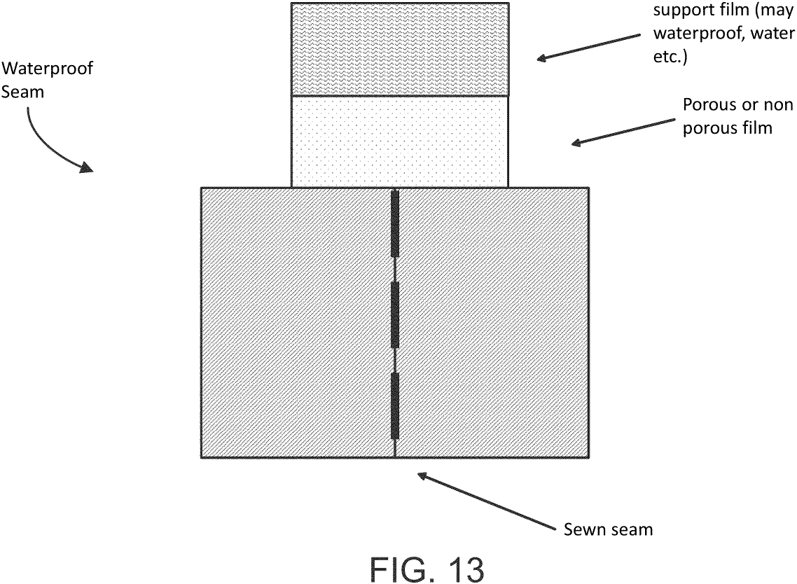

FIG. 14 is a schematic drawing of some embodiments described herein.

FIG. 15 is a schematic drawing of some embodiments described herein.

FIG. 16 is a schematic drawing of some embodiments described herein.

FIG. 17 is a schematic drawing of some embodiments described herein.

FIG. 18 is a schematic drawing of some embodiments described herein.

FIG. 19 is a schematic drawing of some embodiments described herein.

FIG. 20 is a schematic drawing of some embodiments described herein.

FIG. 21 is a schematic drawing of some embodiments described herein.

FIG. 22 is a schematic drawing of some embodiments described herein.

### DETAILED DESCRIPTION

### Seam Tape 1

A seam tape described herein comprise, consists of, or consists essentially of a porous or non-porous film, wherein the porous or non-porous film comprises, consists of, or consists essentially of a polypropylene-containing material and has a Vicat softening point of about 150° C. or less, preferably between 45° C. and about 150° C. About 150° C. as used herein, may mean that the porous or non-porous film has a Vicat softening point of 150° C.± 5° C. In some embodiments, the Vicat softening point may be between 50° C. and 145° C., between 60° C. and 140° C., between 70° C. and 130° C., between 80° C. and 120° C., or between 90° C. and 110° C. or between 90° C. and 100° C.

In some embodiments, the polypropylene-containing material may be a polypropylene-containing copolymer, terpolymer, or polymer blend. In some embodiments, the polypropylene-containing material may be a polypropylene-containing copolymer, for example a block copolymer. In some embodiments, the polypropylene-containing copolymer may have greater than 50%, greater than 60%, greater than 70%, greater than 80%, greater than 90%, or greater than 95% polypropylene. In some embodiments, the polypropylene-containing copolymer of polypropylene and another polyolefin. For example, it may be a polypropylene-containing copolymer or block copolymer containing less than 50% polyethylene, preferably less than 40%, less than 30%, or less than 20%, and preferably less than 10% or less than 9%, or 8%, or 7%, or 6%, or 5%, or 4%, or 3%, or 2%, or 1%. In some embodiments, the terpolymer may be one having greater than 50%, greater than 60%, greater than 70%, greater than 80%, greater than 90%, or greater than 95% polypropylene. In some embodiments, the terpolymer may contain polypropylene and one or more additional polyolefins. For example, an additional polyolefin may be polyethylene. For example, polyethylene may be present in an amount less than 50% polyethylene, preferably less than 40%, less than 30%, or less than 20%, and preferably less than 10% or less than 9%, or 8%, or 7%, or 6%, or 5%, or 4%, or 3%, or 2%, or 1% in the terpolymer. In some embodiments, the polypropylene-containing material may be a polymer blend comprising polypropylene and at least one other polymer having a lower softening point. The polymer blend may greater than 50%, greater than 60%, greater than 70%, greater than 80%, greater than 90%, or greater than 95% polypropylene. In some embodiments, the at least one other polymer having a lower softening point that polypropylene may be a wax, an oligomer, a thermoplastic polyurethane, etc.

In some embodiments, the porous or non-porous film contains 50% or more, 60% or more, 70% or more, 80% or more, 90% or more, 95% or more, or 100% of the polypropylene-containing material.

In some embodiments, the porous or non-porous film is macroporous, microporous, or nanoporous. A microporous or non-porous film may have an average pore size ranging from 0.1 to 100 microns, preferably from 0.1 to 10 or 0.1 to 1 microns. A nanoporous or non-porous film may have pores with an average pore size of 1 to 100 nm.

In some embodiments, the porous or non-porous film is a monolayer, bilayer, trilayer, or multilayer film. For bilayer, trilayer, or multilayer films, the separate layers may be coextruded together, laminated together, or both coextruded and laminated. For example, in some embodiments, two layers may be coextruded together and then laminated to a third layer to form a trilayer film.

In some embodiments, the porous or non-porous film is made by a dry process. In some embodiments, it is made by a dry-stretch process such as the Celgard® dry stretch process.

A dry-process, in some embodiments, is a process that does not use any pore-forming agent/pore-former, or beta-nucleating agent/beta-nucleator. In some embodiments, a dry-process is one that does not use any solvent, wax, or oil. In some embodiments, a dry-process is one that does not use any pore-forming agent/pore former, or beta-nucleating agent/beta-nucleator, and also does not use any solvent, wax, or oil. In such embodiments, the dry process may be a dry-stretch process. An exemplary dry-stretch process known as the Celgard® dry stretch process is described in Chen et al., Structural Characterization of Celgard® Microporous Membrane Precursors:Melt-Extruded Polyethylene Films, J. of Applied Polymer Sci., vol. 53, 471-483 (1994), which is incorporated by reference herein in its entirety. The Celgard® dry stretch process refers to a process where pore formation results from stretching a nonporous oriented precursor at least in the machine direction. Kesting, Robert E., Synthetic Polymeric Membranes, A Structural Perspective, Second Edition, John Wiley & Sons, New York, N.Y., (1985), pages 290-297, also discloses a dry-stretch process and is incorporated herein by reference in its entirety. In a dry-stretch process according to some preferred embodiments, the process may comprise a stretching step. The stretching step may comprise, consist of, or consist essentially of uniaxial stretching (e.g., stretching in only the MD direction or in only the TD direction), biaxial stretching (e.g., stretching in the MD and TD direction), or multi-axial stretching (e.g., stretching along three or more different axes such as MD, TD, and another axis). In some embodiments, the dry-stretch process may comprise, consist of, or consist essentially of an extrusion step and a stretching step, in that order or not in that order. In some embodiments, the dry stretch process may comprise, consist of, or consist essentially of an extrusion step, an annealing step, and a stretching step, in that order or not in that order. The extrusion step, in some embodiments, may be a blown-film extrusion step or a cast-film extrusion process. In some embodiments, a non-porous precursor is extruded and stretched to form pores. In some embodiments, a non-porous precursor is extruded, annealed, and then stretched to form pores. In other embodiments, a porous or non-porous precursor may be formed by a method other than extrusion, such as by sintering or printing, and stretching may be performed on the precursor to form pores or to make existing pores larger.

In some embodiments, pore-forming agent/pore former, or beta-nucleating agent/beta-nucleator may be used and the process is still considered a dry-process. For example, a particle stretch process may be considered to be a dry process because oil or solvent is not extruded with the polymer and extracted from the extruded polymer to form pores. In a particle stretch process, particles such as silica or calcium carbonate are added to a polymer mixture, and these particles help to form the pores. In such a method, for example, the polymer mixture comprising particles and a polymer is extruded to form a precursor that is stretched and voids are created around the particles. In some embodiments, the particles may be removed after the voids are created. While a particle stretch process may include a stretching step before or after the removal of the particles, a particle stretch process is not considered a dry-stretch process because the principle pore formation mechanism is the use of the particles not stretching.

In some preferred embodiments, the structure of a dry-process porous membrane may have one or more distinguishing features. For example, a dry-process membrane may comprise an amount of polypropylene greater than 10%. Wet-processes or other processes using a solvent are not generally compatible with polypropylene because the solvents degrade polypropylene. Thus, wet process porous membranes typically contain no more than 10% polypropylene, and most typically 5% or less. One other distinguishing feature of some dry process porous membranes, particularly those used as battery separators, is the ability to have a shutdown function. Shutdown function may be imparted, in some cases, by a PP/PE/PP structure. This is unique to dry-process membranes because layers comprising mainly polypropylene (PP) generally cannot be formed in a wet process. A dry process is uniquely suited to form a PP/PE/PP shutdown membrane structure.

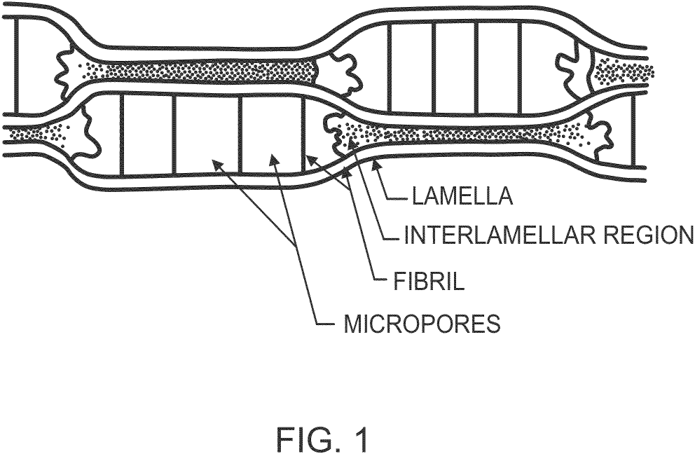

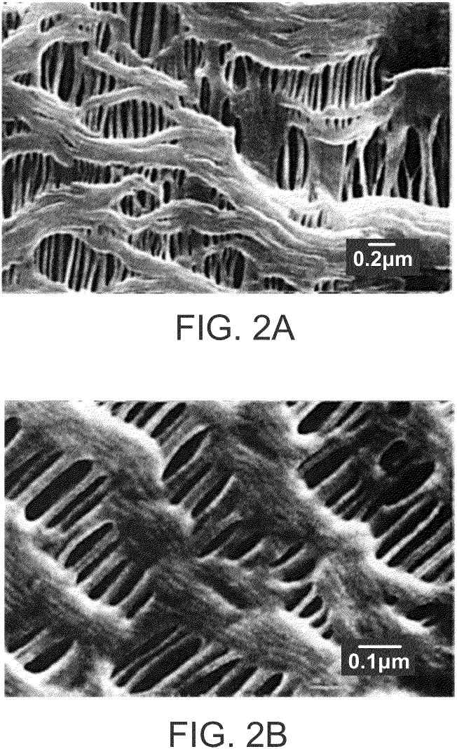

In some embodiments, a distinguishing dry-process porous membrane may be the presence of lamellae and fibrils. For example, the porous membrane may have a structure like that shown in FIG. 1 of FIGS. 2A and 2B. FIGS. 2A and 2B are FESM images showing slit-like micropores in Celgard® microporous membranes comprising PE (A) and PP(B). In some embodiments, the pores or micropores of a dry-process porous membrane may be round, oblong, semi-round, trapezoidal, etc.

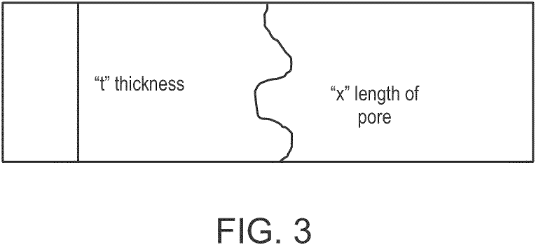

In some embodiments, a distinguishing feature of a dry-process porous membrane is that it contains no or substantially no pin-holes. Pin-holes are considered a defect, and generally are not an intentionally formed feature of a dry-process porous membrane. In some embodiments, the dry-process microporous membrane may contain no or substantially no pin-holes greater than 10 nm. In some preferred embodiments, the pores of a dry-process porous membrane are tortuous. In some embodiments, a distinguishing feature of a dry-process porous membrane is tortuosity. In some embodiments, the tortuosity of a dry-process porous membrane is greater than 1, greater than 1.2, greater than 1.3, greater than 1.4, greater than 1.5, greater than 1.6, greater than 1.7, greater than 1.8, greater than 1.9, or greater than 2.0. In some embodiments, a formula for calculating tortuosity crudely is formula (1): Tortuosity=x/t (1) where “x” is the length of the opening or pore in a porous membrane and “t” is the thickness of the membrane. A pin-hole has a tortuosity of 1 because the length of the pin hole is the same as the thickness of the membrane. A tortuous pore has a tortuosity greater than 1 as shown in FIG. 3 because the length of the pore is longer than the thickness of the membrane.

In some embodiments, the dry-stretch porous membrane is semi-crystalline. In some embodiments, the dry-stretch porous membrane is semi-crystalline and oriented in a single direction. For example, the membrane may be MD-oriented. A porous or non-porous film formed by a wet process, such as a film formed by a beta-nucleation process, may be randomly oriented.

In some embodiments, the seam tape described herein may comprise, consist of, or consist essentially of the porous or non-porous film described herein and at least one selected from the group consisting of a release film or layer and a support film or layer. In some embodiments, a release film or layer may be provided on opposing surfaces of the porous or non-porous film. In some embodiments, a support film may be provided on one surface of the porous or non-porous film and a release film or layer may be provided on an opposing side. The release film or layer is not so limited. One purpose of the film is to protect the porous or non-porous film from contamination before it is used for at least one of bonding a seam, water proofing a seam, or reinforcing a seam. For example, the release film or layer may protect the porous or non-porous film while the seam tape is stored, shipped, or before use. The release film or layer sticks to the porous or non-porous film, but can be easily removed without damaging the porous or non-porous film. In some embodiments, the release film or layer may be paper or a plastic film or layer. The support film described herein is also not so limited. In contrast to the release film or layer, the support film or layer is not removed from the porous or non-porous film. In some embodiments, the material of the support film may be a fabric such as a jersey fabric, a nylon-containing fabric, or a spandex-containing fabric. In some embodiments, the support film may be made of one of the materials used in the seam. For example, if the seam tape is used to reinforce a seam, the support material may be made of at least one of the materials used to form a bonded seam.

### Seam Tape 2

A seam tape comprising, consisting of, or consisting essentially of a polyolefin-containing adhesive is described. The polyolefin-containing adhesive may be free-standing or self-supported, or the adhesive may be provided on a support. The support may be a monolayer, bilayer, trilayer, or multilayer (four or more layers) support.

The polyolefin-containing adhesive is not so limited. In some embodiments, the polyolefin-containing adhesive may be a polyolefin hot melt adhesive. In some embodiments, a surface of the polyolefin-containing adhesive may be formed or treated so that properties of the surface are modified. For example, the tackiness of the surface may be increased by addition of a tackifier to the adhesive or by treatment of the adhesive surface to improve tackiness.

In some embodiments, one or two surfaces of the polyolefin-containing adhesive may have a release liner thereon to, for example, protect the adhesive from contaminants. In embodiments where the polyolefin-containing adhesive is freestanding or self-supported, one or both sides of the adhesive may. The material of the release liner is not so limited. The release liner should however be able to tack to the adhesive and be removed from the adhesive without taking an appreciable amount with it and leaving the adhesive layer mainly intact.

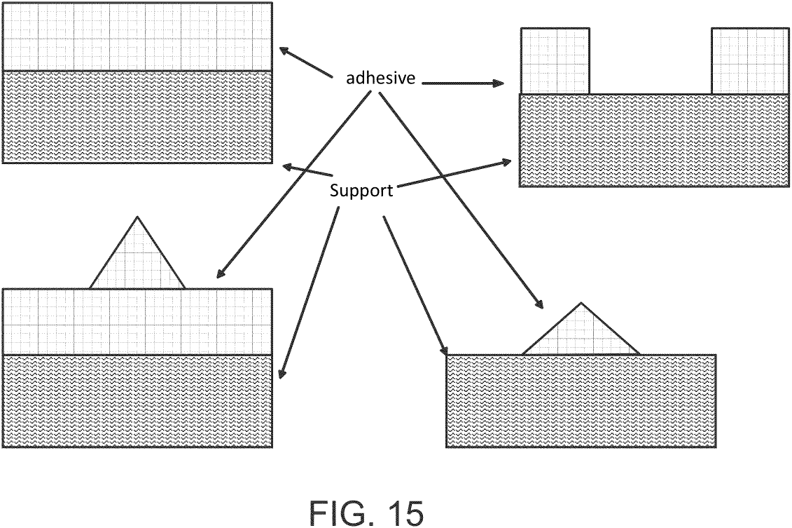

In some embodiments, the polyolefin-containing adhesive may be formed on a support. For example, the adhesive may be formed continuously or non-continuously on the support. For example, a non-continuous dot pattern may be formed or a continuous grid pattern may be formed. In some embodiments, the adhesive may cover the entire surface of the support and in other embodiments it may cover less than the entire surface of the support. Sometimes the adhesive may cover 90% or more, 80% or more, 70% or more, 60% or more, 50% or more, 40% or more, 30% or more, 20% or more, or 10% or more of a support surface. FIG. 15 shows examples of continuous (two left examples) and non-continuous (two right examples) adhesive coverage. The triangular portion of adhesive may be useful for getting the adhesive into the crevices of a seam such as a bias bound seam. The triangular shape is only representative, and the shape may also be, for example, more rounded.

The structure and composition of the support is not so limited. In some embodiments, the support layer may be a monolayer support, a bilayer support, a trilayer support, or a multilayer (four or more layers) support. In some embodiments, the support may be made from at least one selected from the group consisting of a fabric, a textile, a polyolefin-containing film, and a polyurethane-containing film. The fabric, in some embodiments, may be a jersey fabric, nylon fabric, a spandex fabric, etc. In some embodiments, the support may be made of or include a textile as described in U.S. Pat. No. 9,783,914, which lists Celgard LLC as an applicant and is incorporated by reference herein in its entirety. In some embodiments, the fabric or textile may be one made with polyolefin-containing fibers.

The polyolefin-containing film is not so limited and may be porous or non-porous and may comprise, consist of, or consist essentially of polyolefin. The polyolefin may be, in some embodiments, homopolymers, copolymers, or terpolymers of polyethylene, polypropylene, or both. In some embodiments, a polymer blend of a polyolefin and a polymer other than a polyolefin may be used. A polyolefin polymer blend may comprise a majority polyolefin. The polyolefin-containing film may be any of the porous or non-porous films described hereinabove that also contain polyolefin. In some embodiments, the polyolefin-containing film may be a porous one as described in U.S. Pat. No. 9,783,914, which lists Celgard LLC. In some embodiments, the polyolefin-containing film may be a porous dry-stretch process film that contains polyolefin.

In some embodiments, the support may be a bilayer support where each of the two layers is made from the same or a different material. In an embodiment where each layer is made from a different material, one layer may be a fabric or textile as described herein, and the other layer may be a polyolefin-containing film as described herein. In some embodiments, the seam tape comprising a bilayer support may include a fabric or textile, a polyolefin-containing film, and a polyolefin-containing adhesive in that order. A release film or layer may be formed on an exposed surface of the polyolefin-containing adhesive to, for example, protect it. In some embodiments, the fabric or textile may comprise, consist of, or consists essentially of polyolefin. For example, the textile may be made of polyolefin-containing fibers.

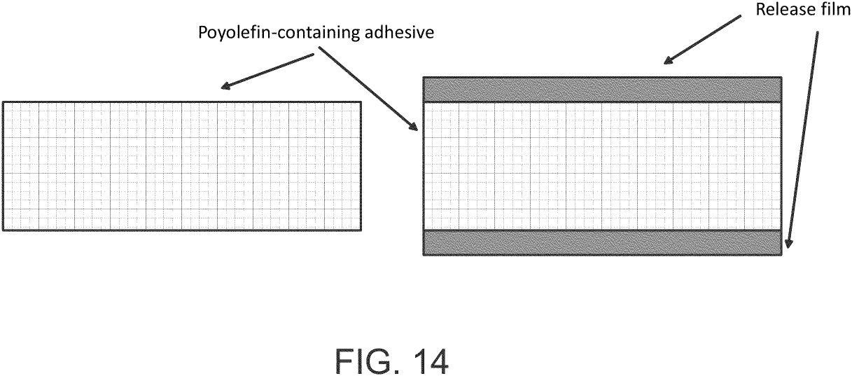

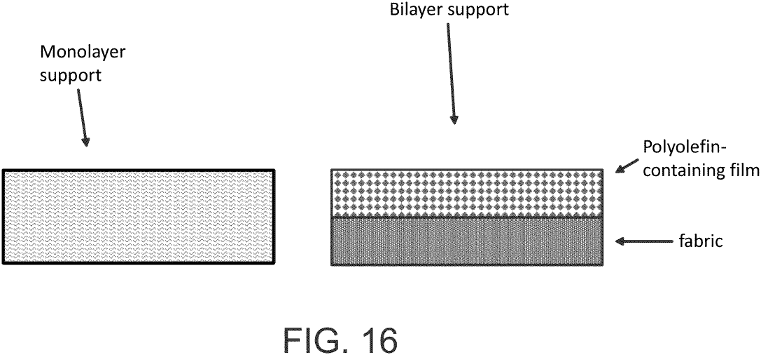

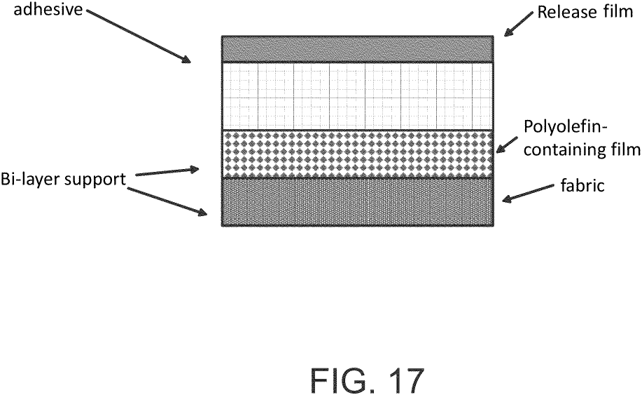

An exemplary seam tape 2 is shown in, for example, FIGS. 14-17. In each embodiments, the adhesive may be replaced with a porous or non-porous film or a bonding layer as described herein.

### Seam Tape 3

In another aspect, a seam tape comprising, consisting of, or consisting essentially of a bonding layer is described. The material of the bonding layer is not so limited.

In some preferred embodiments, the bonding layer comprises, consists of, or consists essentially of a polyolefin. For example, the polyolefin may be a low density or very low density polyolefin. In some embodiments, the polyolefin may be one that has a softening point between less than about 110° C. In some preferred embodiments, the softening point of the polyolefin may be less than 100° C., less than 95° C., less than 90° C., less than 80° C., less than 70° C., or less than 60° C. In preferred embodiments, the polyolefin has a softening point above 45° C. or above 50° C. so that the bonding layer does not soften when exposed to extreme temperatures that a garment or a piece of equipment utilizing the seam tape may be exposed to. The polyolefin may be a polyethylene or polypropylene homopolymer, copolymer, terpolymer. In some embodiments, a polyolefin blend may be used. A polyolefin blend may include a mixture of two or more polyolefins or a mixture of one or more polyolefins with another polymer. In some embodiments, the polyolefin may be a polypropylene-polyethylene block copolymer wherein the amount of polyethylene is up to 49%, preferably up to 40%, 30%, or 20%, and most preferably up to 10% or 5%.

In some embodiments, the bonding layer may exhibit tack or be modified to exhibit tack. This makes it easier to place the tape when using it to bond, reinforce, or waterproof a seam. It prevents the seam tape from moving easily.

In some embodiments, the bonding layer may be self-supported or free-standing, and in some embodiments, the bonding layer may be formed on a support. In either arrangement, a release film as described herein may be formed on any exposed surface of the bonding layer to, for example, protect it.

The support is not so limited. In preferred embodiments, the support is made of a material that will not melt, soften, or deform at a temperature at which the bonding layer will. In preferred embodiments, the support has a softening point that is at least 20° C., at least 30° C., at least 40° C., at least 50° C., at least 60° C., at least 70° C., or at least 80° C. higher than that of the bonding layer. The support may be a monolayer support, a bilayer support, a trilayer support, or a multilayer (4 or more layers) support.

In some preferred embodiments, the support is a bilayer support. In some embodiments, the bilayer support may comprise a breathable/waterproof layer and an exposed layer in that order. In some preferred embodiments, the bonding layer is formed on the breathable/ waterproof layer. It may be formed directly on the layer or indirectly (e.g., with an intervening layer formed in between) on the breathable/waterproof layer.

The breathable/waterproof layer is not so limited and may be breathable, waterproof, or both. Waterproof may mean that the layer exhibits a waterproofing rating of 6,000 mmH₂O or above, 10,000 mmH₂O or above, 20,000 mmH₂O or above, 30,000 mmH₂O or above, or 40,000 mmH₂O or above. Breathable may mean that the layer has a breathability of 5,000 g/m²/24 hrs or more, 10,000 g/m²/24 hrs or more, 20,000 g/m²/24 hrs or more 30,000 g/m²/24 hrs or more, 40,000 g/m²/24 hrs or more, 50,000 g/m²/24 hrs or more, 60,000 g/m²/24 hrs or more, 70,000 g/m²/24 hrs or more, 80,000 g/m²/24 hrs or more, 90,000 g/m²/24 hrs or more, 100,000 g/m²/24 hrs or more, 110,000 g/m²/24 hrs or more, 120,000 g/m²/24 hrs or more, or 130,000 g/m²/24 hrs or more.

The material of the breathable/waterproof layer is not so limited. In some embodiments, the breathable/waterproof layer may comprise, consist of, or consist essentially of a polyolefin. The polyolefin may be a polyethylene or polypropylene homopolymer, copolymer, terpolymer. In some embodiments, a polyolefin blend may be used. A polyolefin blend may include a mixture of two or more polyolefins or a mixture of one or more polyolefins with another polymer. In some embodiments, the polyolefin may be a polypropylene-polyethylene block copolymer wherein the amount of polyethylene is up to 49%, preferably up to 40%, 30%, or 20%, and most preferably up to 10% or 5%.

In preferred embodiments, the breathable/waterproof layer has a softening point that is at least 20° C., at least 30° C., at least 40° C., at least 50° C., at least 60° C., at least 70° C., or at least 80° C. higher than that of the bonding layer. In some preferred embodiments, the softening point of the layer is above about 150° C.

The exposed layer is not so limited. In some embodiments, the exposed layer and the breathable/waterproof material may be the same or different. In some embodiments, the exposed layer may be a fabric or textile as disclosed anywhere herein. In some embodiments, the exposed layer may comprise, consist of, or consist essentially of a polyolefin. For example, the exposed layer may be a textile made with polyolefin-containing fibers. The polyolefin of the exposed layer may be a polyethylene or polypropylene homopolymer, copolymer, terpolymer. In some embodiments, a polyolefin blend may be used. A polyolefin blend may include a mixture of two or more polyolefins or a mixture of one or more polyolefins with another polymer. In some embodiments, the polyolefin may be a polypropylene-polyethylene block copolymer wherein the amount of polyethylene is up to 49%, preferably up to 40%, 30%, or 20%, and most preferably up to 10% or 5%. In some embodiments, the exposed layer has good hand. For example, if the seam tape is used on an interior seam of a garment, an exposed layer with a soft hand would be preferred. In some embodiments, an exterior layer with a stiffer hand may be preferable.

In preferred embodiments, the exposed layer has a softening point that is at least 20° C., at least 30° C., at least 40° C., at least 50° C., at least 60° C., at least 70° C., or at least 80° C. higher than that of the bonding layer. In some preferred embodiments, the softening point of the exposed layer is above about 150° C.

In some preferred embodiments, when the seam tape is a bilayer, trilayer, or multilayer seam tape, two or more of the layers of the seam tape are coextruded. In some embodiments, all of the layers are coextruded.

In some preferred embodiments, the seam tapes described herein are recyclable.

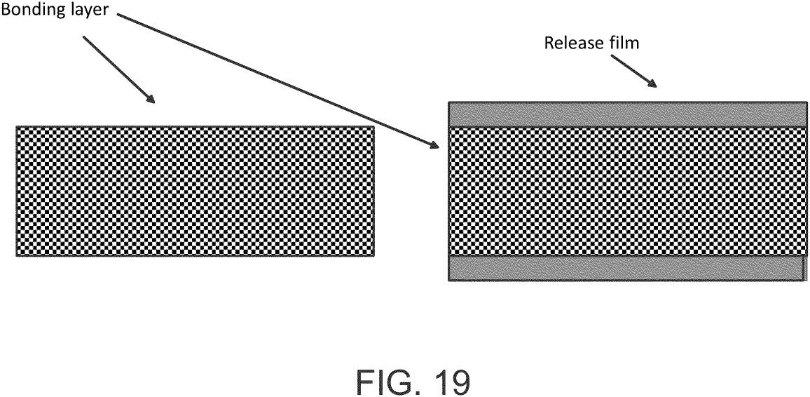

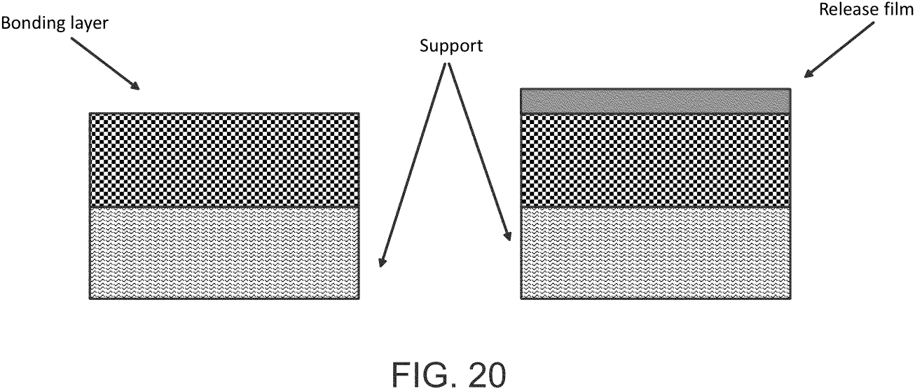

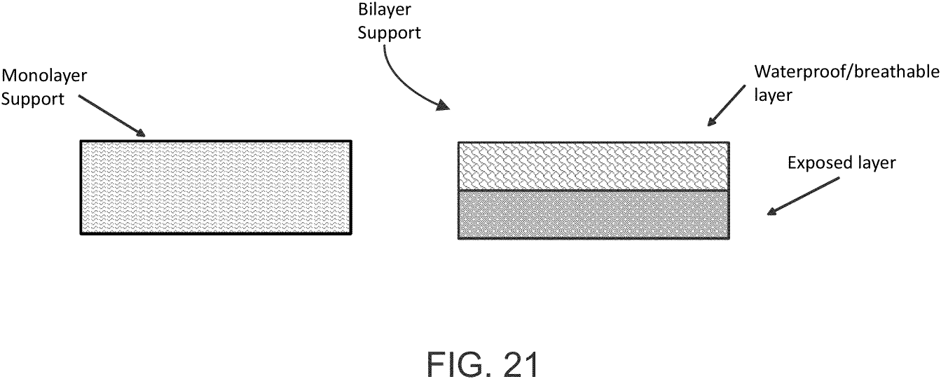

An exemplary seam tape 3 is shown in, for example, FIGS. 19-21. In each embodiments, the bonding layer may be replaced with a porous or non-porous film or an adhesive layer as described herein.

### Methods

Methods for forming seams are disclosed herein. The type of seams formed using the seam tapes descried herein include, but are not limited to, are bonded seams, reinforced seams, or waterproofed seams.

### Method for Bonding a Seam or Forming a Bonded Seam

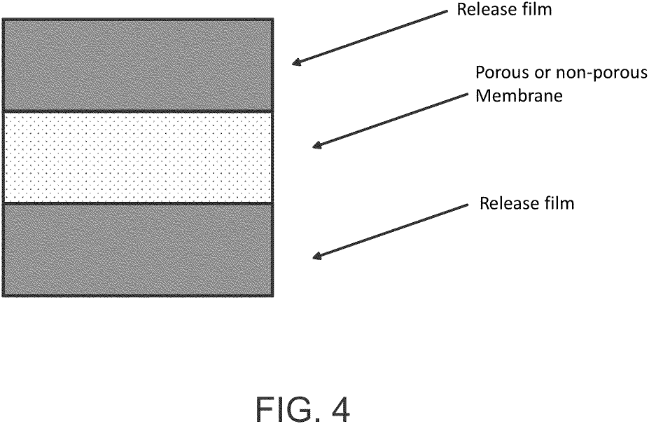

The method is not so limited, and may comprise a step of providing a seam tape as described herein and a step of providing two pieces of material or two sides of a material to be bonded together. In some embodiments, the seam tape may be one as shown in FIG. 4. In other embodiments, the porous or non-porous membrane of FIG. 4 may be a bonding layer or a polyolefin-containing adhesive layer as described herein. The release films shown in FIG. 4 are optional, and may be formed on one or both sides of the porous or non-porous film, the bonding layer, or the polyolefin-containing adhesive layer.

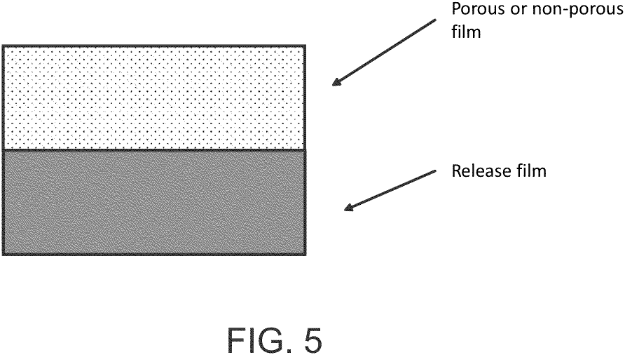

In some embodiments, when a release film is used on both sides as shown on both sides, one release film is removed before the seam tape is used. This is shown in FIG. 5.

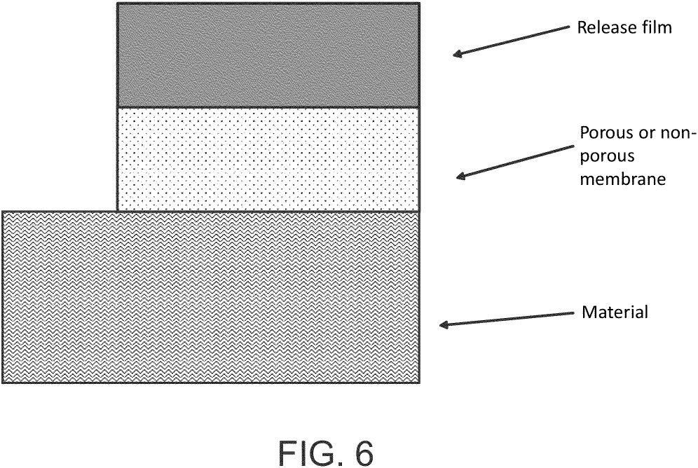

In some embodiment, the method may further comprise placing one side of the seam tape onto a surface of one piece of material or on one side of a material to be bonded together. This is shown in FIG. 6. In some preferred embodiments, the bonding layer as described herein, the polyolefin-containing adhesive layer as described herein onto a surface of one piece of material or on one side of a material to be bonded together. In some embodiments, placing may involve tacking a side of the seam tape to one or more of the pieces of material.

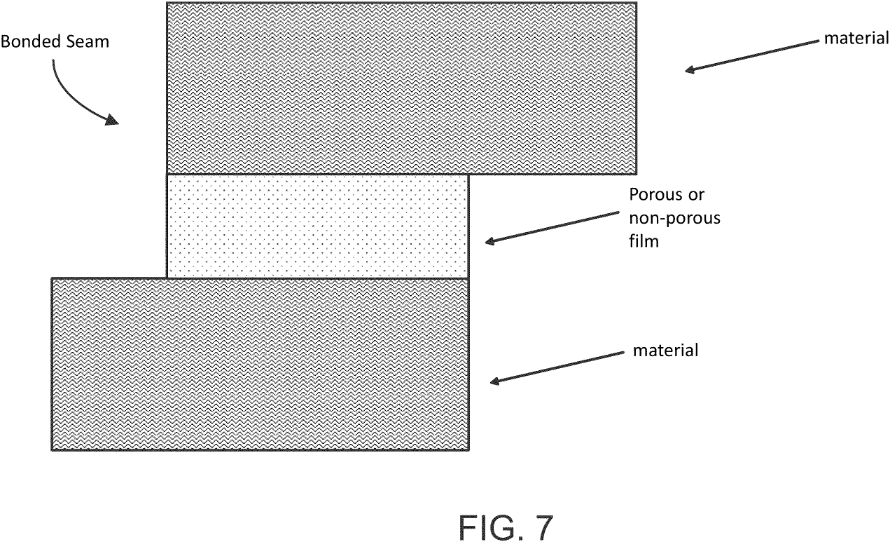

In another aspect, in embodiments where a release liner remains, it is removed in a next step. This is shown by the difference in FIG. 6 and FIG. 7. Then the other piece of material or the other side of a piece of material are placed in contact with the exposed side of the porous or non-porous membrane or to an exposed side of the bonding layer or polyolefin-containing adhesive layer when either of those are used instead of the porous or non-porous film. This is shown in FIG. 7. Placing, in some embodiments, may involve tacking. Next, heat may be applied to form the bond. Heat may be applied by at least one selected from the group consisting of a heat press machine, a lamination belt, an iron, and a hot air machine. Heat may be applied directly or indirectly to the seam tape. Heat may soften, deform, or melt the porous or non-porous layer, the polyolefin-containing adhesive, or the bonding layer, to form the bond. The seam formed is a bonded seam and in some preferred embodiment not sewing is performed. No sewn seam is formed.

In another embodiment, a bonded seam may be formed by using a seam tape herein to form a bias bound seam. In some preferred embodiments, no sewing is performed.

### Method for Reinforcing a Seam or Forming a Reinforced Seam

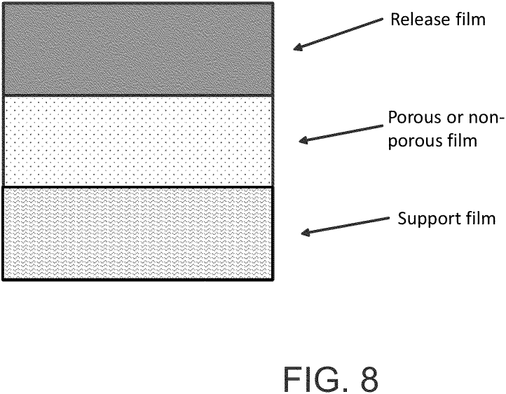

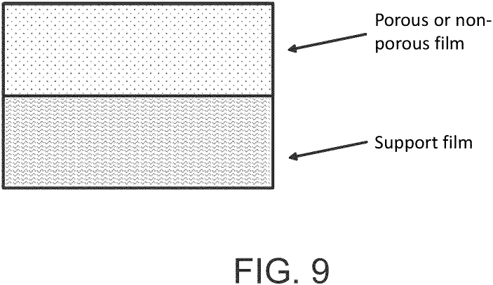

The method for reinforcing a seam is not so limited. An exemplary embodiment is shown in FIGS. 8-10. In some embodiments, the seam tape used for such a method may be one as shown in FIG. 8. The porous or non-porous film may be replaced with a bonding layer or polyolefin-containing adhesive layer as described herein, and the support film may be any monolayer, bilayer, trilayer, or multilayer film as described herein. The release film as shown in FIG. 8 is optional and may be removed before the seam tape is used as shown in the difference between FIG. 8 and FIG. 9. Next, the seam tape is placed over a seam to reinforce it. The seam may be a sewn seam, an ultrasonic line bonded seam, or the like. Placing may involve tacking. In preferred embodiments, the method may further comprise applying heat to the seam directly or indirectly. Heat may be applied using at least one selected from the group consisting of: a heat press machine, a lamination belt, an iron, and a hot air machine. Heat may be described directly or indirectly. Heating the seam tape melts, softens or deforms the porous or non-porous film, the adhesive, or the bonding layer to form a bond between the seam tape and the seam and the area around the seam.

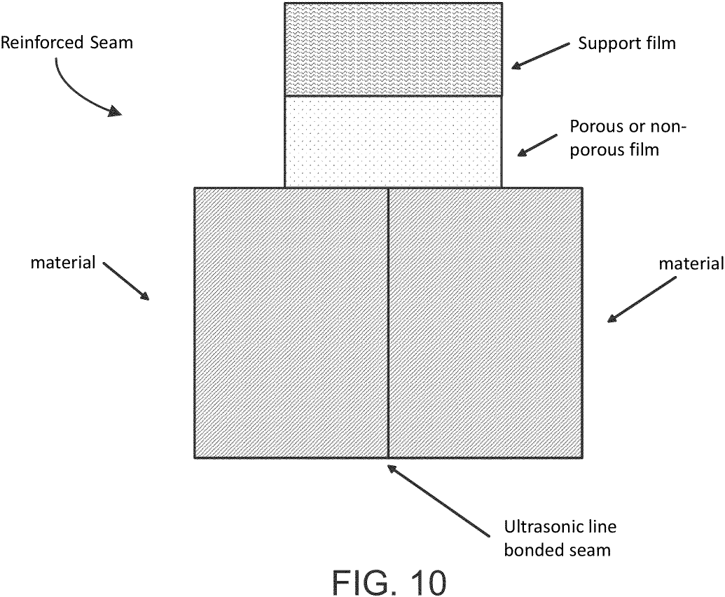

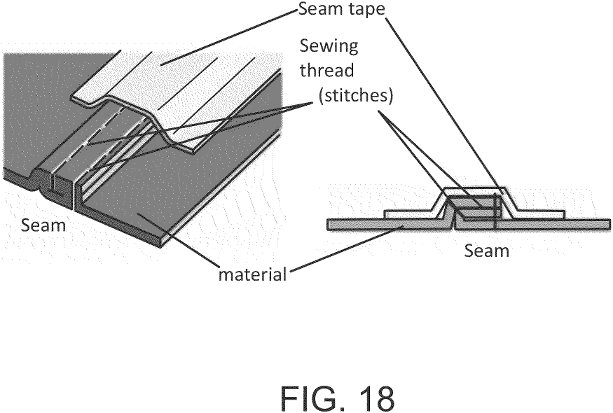

Exemplary reinforced seams are shown in FIG. 10 and FIG. 18.

### Method for Waterproofing a Seam or Forming a Waterproof Seam

The method for waterproofing a seam is not so limited. In some embodiments, the method for waterproofing a seam using a seam tape described herein is disclosed. The method may comprise a step of placing the seam tape on the seam. Placing may involve tacking. In further embodiments, the method may further comprise applying heat to the seam directly or indirectly. Heat may be applied using at least one selected from the group consisting of: a heat press machine, a lamination belt, an iron, and a hot air machine. In some embodiments, the seam that is undergoing waterproofing is a sewn seam.

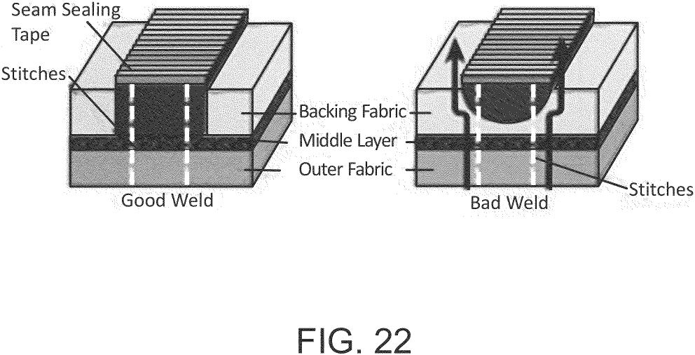

An exemplary sealed or waterproofed seam is shown in, for example, FIG. 22. In this Figure, it shows that the seam tape softens, melts, or deforms to penetrate all the way down to the middle layer of a material that has three layers. Commonly, the outer layer of the material may be water proof, while the middle and backing fabric of the material may not. The seam tape must form a seal around the stitches all the way through to the outer layer so that waterproofness is maintained. A bad weld or seal is shown on the left where the seam tape has not softened, melted or, deformed to penetrate all the way down to the outer waterproof layer of the material or materials forming the seam.

### Article

In some embodiments, any one seam tape herein may be used to form an article such as a garment (shoes, shirt, gloves, jacket, pants, socks, shoes, etc.), outdoor equipment (tent, tarp, backpack, sleeping bag, mat, cot, boat cover, outdoor furniture upholstery, grill covers, backpacks, etc.), sheets, medical gowns, blankets, and sheets, or the like. In some embodiments, the article may be industrial protective and high visibility clothing, an article for military use, an article for emergency service use, an article for public service use, leisure waterproofs, wet suits, dry suits, waders, boots, socks, shoe sock liners, an article for motor vehicles, a chemical protective clothing article.

In some embodiments, the article may be recyclable or may be recyclable after removal of minor parts (e.g., zippers, buttons, snaps, etc., which may be made of metal) that are not recyclable. In some preferred embodiments, the articles may comprise, consist of, or consist essentially of polyolefin. In some preferred embodiments, all of the article except minor portions (snaps, zippers, buttons, etc., which may be made of metal).In some embodiments, the polyolefin may be a polypropylene or polyethylene copolymer, homopolymer, or terpolymer, or a polyolefin polymer blend comprising a mixture of polyolefins or a mix of polyolefin and another non-polyolefin. The polyolefin polymer blend contains a majority polyolefin. In some embodiments, a polypropylene-containing polymer, copolymer, terpolymer, or polymer blend is used. In some embodiments, the materials and the seam tape consist or consist essentially of a polypropylene-containing polymer, copolymer, terpolymer, or polymer blend. In some embodiments, the polyolefin is a polypropylene-containing copolymer. In some embodiments, the polyolefin is a polypropylene-polyethylene block copolymer wherein the amount of polyethylene is up to 49%, preferably up to 40%, 30%, or 20%, and most preferably up to 10% or 5%.

In one aspect, a waterproof seam comprising a seam tape disclosed herein is disclosed. In some embodiments, the materials forming the seam and the seam tape comprise, consist of, or consist essentially of a polypropylene-containing polymer, copolymer, terpolymer, or polymer blend. In some embodiments, the materials and the seam tape consist or consist essentially of a polypropylene-containing polymer, copolymer, terpolymer, or polymer blend. In some embodiments, the materials and the seam tape consist of or consist essentially of a polypropylene-containing copolymer. In some embodiments, the materials and the seam tape consist of or consist essentially of a polypropylene-polyethylene block copolymer wherein the amount of polyethylene is up to 49%, preferably up to 40%, 30%, or 20%, and most preferably up to 10% or 5%.

Various embodiments in this disclosure have been described in fulfillment of the various objectives of the invention. It should be recognized that these embodiments are merely illustrative of the principles disclosed. Numerous modifications and adaptations thereof will be readily apparent to those skilled in the art without departing from the spirit and scope of the invention.

1. A seam tape comprising, consisting of, or consisting essentially of a porous or non-porous film that comprises, consists of, or consists essentially of a polypropylene-containing material that has a Vicat softening point of about 150° C. or less.

2. (canceled)

3. The seam tape of claim 1, further comprising at least one selected from the group consisting of a release film, a support film, or both on one or both sides of the porous or non-porous film, optionally wherein:
the porous or non-porous film has a release layer on one side of the porous or non-porous film and a support film on the other side;
the porous or non-porous film has a release layer on one or both sides thereof;
the porous or non-porous film has a support film on one or both sides thereof; and/or
the seam tape further comprises at least one support film made from the group consisting of a fabric, including a jersey fabric, nylon fabric, a spandex fabric, etc., a polyolefin-containing film, and a polyurethane-containing film.

4. (canceled)

5. (canceled)

6. (canceled)

7. (canceled)

8. The seam tape of claim 1, wherein the porous or non-porous film is a porous film that is nanoporous, microporous, or macroporous.

9. (canceled)

10. (canceled)

11. (canceled)

12. (canceled)

13. The seam tape of claim 1 wherein the polypropylene-containing material has a Vicat softening point between 45° C. and about 150° C.

14. The seam tape of claim 1 wherein the polypropylene-containing material is a copolymer containing more than 50%, 60%, 70%, 80%, 90%, or 95% polypropylene, a terpolymer containing more than 50%, 60%, 70%, 80%, 90%, or 95% polypropylene, a polymer blend containing more than 50%, 60%, 70%, 80%, 90%, or 95% polypropylene, or a mixture containing more than 50%, 60%, 70%, 80%, 90%, or 95% polypropylene.

15. (canceled)

16. (canceled)

17. (canceled)

18. (canceled)

19. (canceled)

20. The seam tape of claim 14 wherein the polypropylene-containing material is a polypropylene-polyethylene copolymer, block copolymer, terpolymer, or block terpolymer.

21. (canceled)

22. (canceled)

23. The seam tape of claim 14 wherein the copolymer, terpolymer, or mixture contains polypropylene and another polyolefin, which may be polyethylene.

24. (canceled)

25. The seam tape of claim 1 wherein the seam tape is a seam reinforcement tape, a seam bonding tape, or a seam waterproofing tape.

26. (canceled)

27. (canceled)

28. (canceled)

29. A method for bonding a seam using a seam tape of claim 1 comprising:
bonding at least two pieces of material together using the seam tape, wherein the pieces of material may be the same type of material or different types of material.

30. (canceled)

31. (canceled)

32. (canceled)

33. (canceled)

34. (canceled)

35. (canceled)

36. A method for reinforcing a seam using the seam tape of claim 1 comprising placing the porous or non-porous film over the seam, wherein:
the seam is approximately centered under the seam tape;
the seam is at least one of a sewn seam and an ultrasonic line bonded seam; and/or
the method further comprises applying heat where heat may be applied by at least one selected from the group consisting of a heat press machine, a lamination belt, an iron, and a hot air machine.

37. (canceled)

38. (canceled)

39. (canceled)

40. (canceled)

41. A method for waterproofing a seam using the seam tape of claim 1 comprising:
placing the porous or non-porous film on the seam, wherein:
the method further comprises applying heat to the seam, wherein heat may be applied by at least one selected from the group consisting of a heat press machine, a lamination belt, an iron, and a hot air machine; and/or
the seam is a sewn seam.

42. (canceled)

43. (canceled)

44. (canceled)

45. A reinforced, bonded, or waterproof seam comprising the seam tape of claim 1.

46. (canceled)

47. (canceled)

48. The seam of claim 45 -47, wherein materials forming the seam and the seam tape comprise, consist of, or consist essentially of a polypropylene-containing polymer, copolymer, terpolymer, or polymer blend.

49. (canceled)

50. (canceled)

51. The seam tape of claim 48, wherein the materials and the seam tape consist of or consist essentially of a polypropylene-polyethylene block copolymer wherein the amount of polyethylene is up to 49%, preferably up to 40%, 30%, or 20%, and most preferably up to 10% or 5%.

52. (canceled)

53. A seam tape comprising, consisting of, of consisting essentially of a polyolefin-containing adhesive, optionally wherein:
the polyolefin-containing adhesive is at least one selected from the group consisting of a hot melt adhesive and a pressure sensitive:
the seam tape consists of or consists essentially of a polyolefin-containing adhesive in the form of a film, layer, or strip wherein the surface of the film, layer, or strip may be optionally formed or treated to improve properties such as tack;
the seam tape comprises a substrate or support and the polyolefin-containing adhesive formed continuously or non-continuously on the substrate or support;
the seam tape comprises a substrate or support and the polyolefin-containing adhesive formed continuously or non-continuously on the substrate or support, wherein the support or substrate is made from the group consisting of a fabric, including a jersey fabric, nylon fabric, a spandex fabric, etc., a polyolefin-containing film, and a polyurethane-containing film;
the seam tape comprises a substrate or support and the polyolefin-containing adhesive formed continuously or non-continuously on the substrate or support, wherein the substrate or support comprises two or more layers that are made of the same or different material; and/or
the seam tape comprises a substrate or support and the polyolefin-containing adhesive formed continuously or non-continuously on the substrate or support, wherein the substrate or support comprises two or more layers that are made of the same or different material, and wherein one of the layers is a polyolefin-containing film and another is a fabric, including a fabric made from polyolefin-containing fibers.

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. The seam tape of claim 53, wherein the polyolefin-containing adhesive, the polyolefin-containing film, and the fabric are formed in that order.

68. The seam tape of claim 53, wherein the polyolefin-containing film is porous or non-porous.

69. The seam tape of claim 68, wherein the polyolefin-containing film is porous.

70. The seam tape of claim 68, wherein the polyolefin-containing film is non-porous.

71. The seam tape of claim 53, wherein a release film or layer is formed on an exposed surface of the polyolefin-containing adhesive.

72. A seam comprising the seam tape of claim 53 wherein the seam is at least one of a reinforced seam, a bonded seam, and a waterproof seam.

73. (canceled)

74. A method for forming a seam between two or more materials comprising:
providing the seam tape of claim 53, optionally wherein:
the two or more materials are the same or different;
the two or more materials and/or the seam tape consist of or consist essentially of a polypropylene-containing polymer, copolymer, terpolymer, or polymer blend;
the two or more materials and/or the seam tape consist of or consist essentially of a polypropylene-containing copolymer; and/or
the two or more materials and/or the seam tape consist of or consist essentially of a polypropylene-polyethylene block copolymer wherein the amount of polyethylene is up to 49%, preferably up to 40%, 30%, or 20%, and most preferably up to 10% or 5%.

75. (canceled)

76. (canceled)

77. (canceled)

78. (canceled)

79. (canceled)

80. A seam tape comprising:
a bonding layer comprising a polyolefin.

81. The seam tape of claim 80, further comprising a support, wherein the support may be a monolayer support, a bilayer support, a trilayer support, or a support comprising four or more layers.

82. (canceled)

83. (canceled)

84. (canceled)

85. The seam tape of claim 81, wherein the support is a bilayer support, and the bilayer support comprises:
a breathable/waterproof layer that is at least one of breathable, waterproof, or both; and
an exposed layer.

86. (canceled)

87. (canceled)

88. (canceled)

89. (canceled)

90. (canceled)

91. (canceled)

92. The seam tape of claim 85, wherein the breathable/waterproof layer comprises, consists of, or consists essentially of a polymer having a softening point above about 150° C., optionally wherein:
the polymer is a polyolefin; and/or
the polymer is a polyolefin and the polyolefin is polypropylene homopolymer, polypropylene copolymer, polypropylene terpolymer, or a polypropylene polymer blend ..

93. (canceled)

94. (canceled)

95. (canceled)

96. (canceled)

97. (canceled)

98. The seam tape of claim 85, wherein the bonding layer, the breathable/waterproof layer, and the exposed layer are arranged in that order.

99. The seam tape of claim 85, wherein at least two of the bonding layer, the breathable/waterproof layer, and the exposed layer are coextruded.

100. (canceled)

101. (canceled)

102. A method for forming a seam comprising between two or more materials:
providing the seam tape of claim 80, optionally wherein:
the two or materials may be the same or different;
the seam is at least one selected from a reinforced seam, a bonded seam, and a waterproof seam;
the two or more materials and/or the seam tape consist of or consist essentially of a polypropylene-containino polymer, copolymer, terpolymer, or polymer blend;
the two or more materials and/or the seam tape consist of or consist essentially of a polypropylene-containino copolymer: and/or
the two or more materials and/or the seam tape consist of or consist essentially of a polypropylene-polyethylene block copolymer wherein the amount of polyethylene is up to 49%, preferably up to 40%, 30%, or 20%, and most preferably up to 10% or 5%.

103. (canceled)

104. (canceled)

105. (canceled)

106. (canceled)

107. (canceled)

108. (canceled)

109. A seam comprising the seam tape of claim 80, wherein the seam may be at least one of a reinforced seam, a bonded seam, and a waterproof seam.

110. (canceled)
